(19) United States
(12) Patent Application Publication
(10) Pub. No.: US 2015/0375912 A1
(43) Pub. Date: Dec. 31, 2015

(54) FLEXIBLE PACKAGE

(71) Applicant: Jordan Fall, Mound, MN (US)

(72) Inventor: Jordan Fall, Mound, MN (US)

(73) Assignee: Jordan Fall, Mound, MN (US)

(21) Appl. No.: 14/748,403

(22) Filed: Jun. 24, 2015

Related U.S. Application Data
(60) Provisional application No. 62/016,729, filed on Jun. 25, 2014.

(51) Int. Cl. B65D 75/58; B31B 23/00; B65D 75/30

(52) U.S. Cl. CPC B65D 75/5805; B65D 75/30; B31B 23/00; B31B 2237/10

(57) ABSTRACT

A flexible package may include a front surface, a rear surface, a seal, and a defect. The rear surface may be coupled to the front surface. The front surface and the rear surface may form a bag to hold a product. The seal may join the front surface to the rear surface to seal the bag. The defect may be located in one of the front surface and the rear surface proximate the seal. The defect, upon separation of the front surface from the rear surface at the seal, may be being exposed and operable to remove a portion of the bag from one of the front surface and the rear surface. Removal of the portion may facilitate access to the product.

### CLAIM OF PRIORITY

This application claims the benefit of priority of U.S. Provisional Application Ser. No. 62/016,729, filed Jun. 25, 2014, which is hereby incorporated by reference in its entirety.

### FIELD OF THE DISCLOSURE

The present disclosure relates to flexible packaging. Specifically, the present disclosure relates to flexible packaging with a removable portion.

### BACKGROUND

Flexible packages are used to store and transport items such as food, liquid, and other material content. The flexible packages can also serve as a consumption container. In other words, the flexible package can be used by the end user to consume the contents directly from the package without having to transfer the contents to a bowl, plate, or other container or device.

### SUMMARY

A flexible package may include a front surface, a rear surface, a seal, and a defect. The rear surface may be coupled to the front surface. The front surface and the rear surface may form a bag to hold a product. The seal may join the front surface to the rear surface to seal the bag. The defect may be located in one of the front surface and the rear surface proximate the seal. The defect, upon separation of the front surface from the rear surface at the seal, may be being exposed and operable to remove a portion of the bag from one of the front surface and the rear surface. Removal of the portion may facilitate access to the product.

### BRIEF DESCRIPTION OF THE FIGURES

The above-mentioned and other features and advantages disclosed herein and the manner of attaining them, will become more apparent and the disclosure itself will be better understood by reference to the following description of embodiments taken in conjunction with the accompanying drawings, wherein:

FIGS. 1A, 1B, 1C, 1D and 1E are front elevation views of a flexible package in various states of use according to an example embodiment;

FIG. 2A shows a perspective view of a flexible package according to an example embodiment.

FIG. 2B show a front elevation of a flexible package according to an example embodiment;

FIGS. 3A, 3B, 3C, 3D, 3E, 3F, 3G, 3H, and 3I show various outlines for a portion of a flexible package that is removable from the flexible package according to example embodiments;

FIG. 4 shows a method of creating an outline for a portion of a flexible package that is removable from the flexible package;

FIG. 5 shows a front elevation view of a flexible package having defects located on a side of the flexible package according to an example embodiment;

FIG. 6 shows a perspective view of flexible material having reinforcing members between multiple layers of the flexible material according to an example embodiment;

FIG. 7 shows a method for creating a defect in a flexible package according to an example embodiment; and

FIGS. 8A and 8B show a method for creating a defect in a flexible material used to form a flexible package according to an example embodiment.

Corresponding reference characters indicate corresponding parts throughout the several views. The exemplifications set out herein illustrate example embodiments, and such examples are not to be construed as limiting the scope of the disclosure any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

Products, edible or otherwise, are often packaged in flexible packages. The product may only occupy a portion of the flexible package. The flexible package may be filled with a gas to protect the product from both breakage and spoilage. For example, a snack chip may only occupy half a flexible package in which the shack chip is sold. To protect the snack chip from breakage and spoilage, nitrogen or other inert gasses may fill the remaining volume of the flexible package.

Once the flexible package is open, a user may have to reach half way into to the flexible package to retrieve the product. While reaching into the flexible package, the user may inadvertently contact the flexible package. Depending on the product in the flexible package, the inside of the flexible package may be greasy or have other food stuck to it. Thus, contact with the inside of the flexible package may result in the user getting grease or food on his or her hand.

To minimize contact with the inside of the flexible package and to facilitate access to the product a portion of the flexible package may be removed. To remove the portion of the flexible package a defect may be contained within a seal of the flexible package. The flexible package may include a front surface, a rear surface, the seal, and the defect. The rear surface may be coupled to the front surface to form a bag that may hold the product. The defect may be exposed and operable, upon separation of the front surface from the rear surface at the seal, to allow for removal of a portion of the bag to facilitate access to the product.

The flexible package may further include a score extending from the defect along the front surface. The score may define the portion of the bag to be removed from the flexible package.

The flexible package may further include a reinforcing member. The reinforcing member may be located along the front surface of the flexible package. The reinforcing member may define the portion of the bag to be removed from the flexible package.

The front surface and the rear surface of the flexible package may be formed by a single piece of flexible material.

The defect may include a slit formed in the flexible material at a crease formed by joinder of the front surface and the rear surface.

The defect may include a clipped corner at an edge formed by joinder of the front surface and the rear surface.

The defect may include a notch formed within the seal.

The single flexible material used to form the flexible package may include a first layer of material and a second layer of material. The defect may include a perforation in the first layer of material and not the second layer of material.

A flexible package may include a flexible member, a seal, and a defect. The flexible member may form a bag having a front surface and a rear surface to contain a product. The seal may join the front surface to the rear surface and may seal the product within the bag. The defect may be contained within the seal. The defect may be exposed and operable, upon separation of the front surface from the rear surface, to remove a portion of the bag to facilitate access to the product.

A method for removing a portion of a flexible package from the flexible package may include separating a front surface of the flexible package from a rear surface of the flexible package at a seal to expose a defect in the flexible package; and tearing the flexible package to remove the portion of the flexible package from the flexible package. The operations of separating and tearing may be accomplished in a continuation movement.

The method for removing a portion of a flexible package from the flexible package may include exposing a slit formed at a crease formed by joining the front surface to the rear surface at the seal by separating the front surface of the flexible package from the rear surface of the flexible package.

The method for removing a portion of a flexible package from the flexible package may include tearing the flexible package at a clipped corner located at the seal.

The method for removing a portion of a flexible package from the flexible package may include creating a pocket proximate an opening created by tearing the flexible package. The pocket arranged to house an edible product.

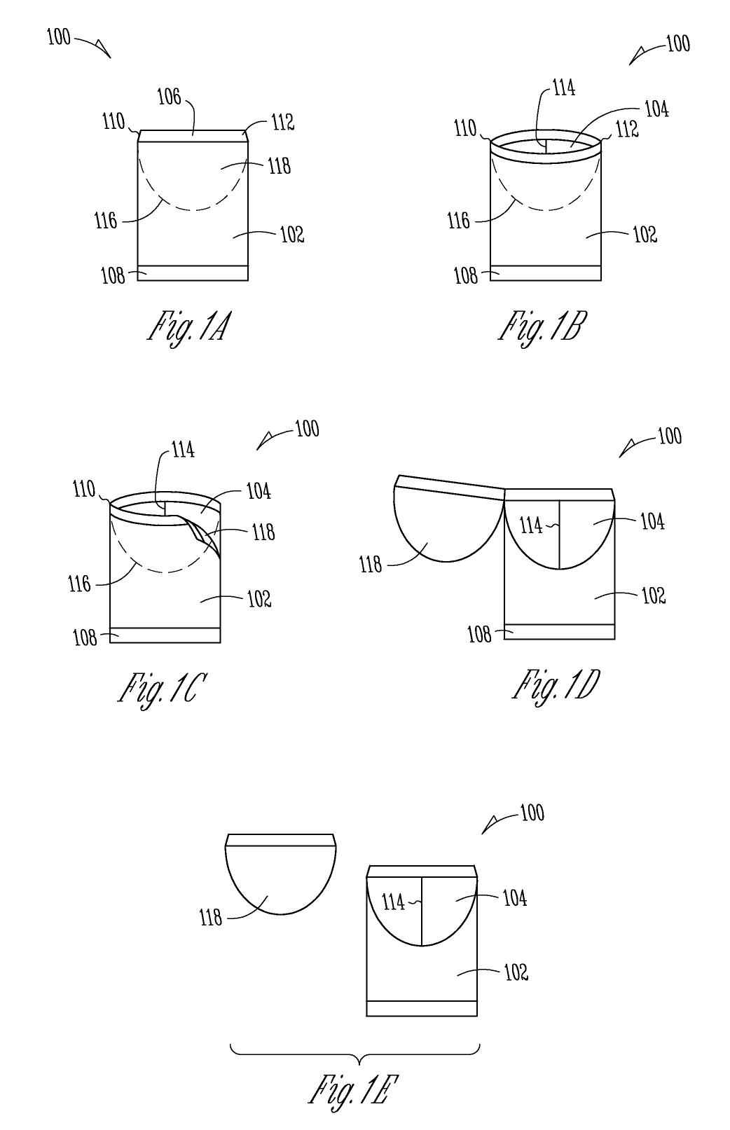

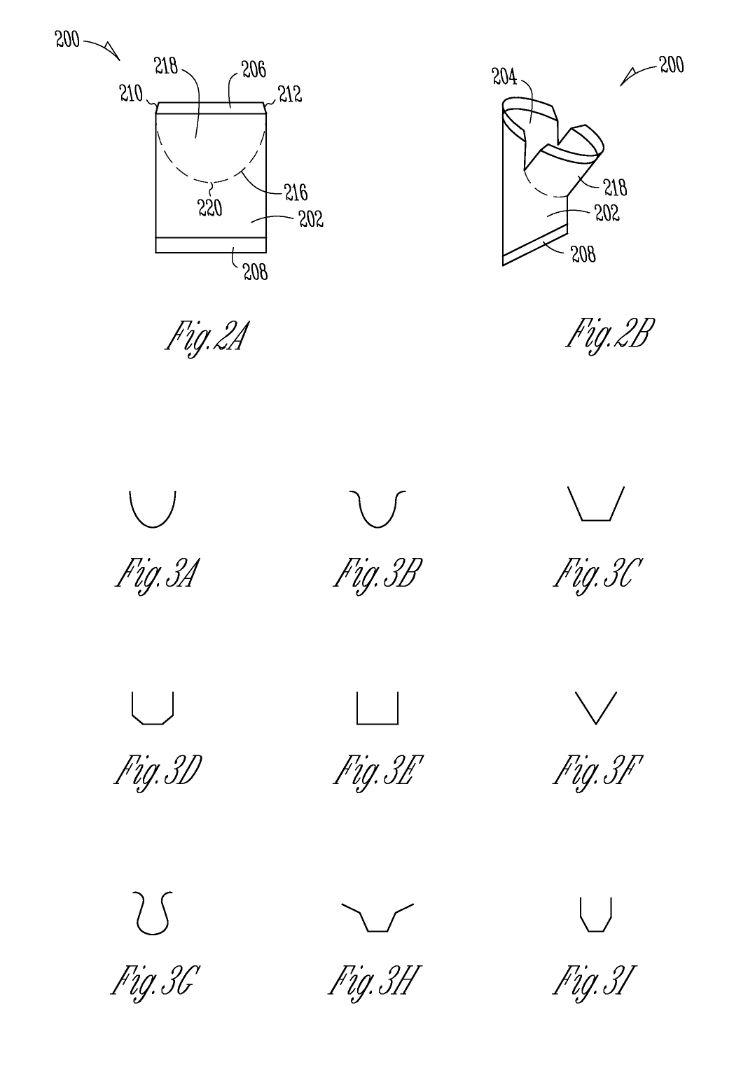

Referring now to the FIGs, FIGS. 1A, 1B, 1C, 1D, and 1E are diagrams that show a flexible package 100. FIG. 1A shows flexible package 100 in a sealed state and FIG. 1B shows flexible package 100 in an unsealed state. Flexible package 100 may include a front surface 102, a rear surface 104, a first seal 106, and a second seal 108. Front surface 102 may be joined to rear surface 104 to form a bag to hold a product. One or more defects, such as for example, a first defect 110 and a second defect 112, may be contained within first seal 106. The one or more defects, upon being exposed by opening flexible package 100 at first seal 106, may be operable to facilitate removal of a portion 118 to allow access to the product stored within flexible package 100.

First defect 110 and second defect 112 may be proximate (e.g., within a short distance of, such as 1-3 mm or closer) a corner of flexible package 100. First defect 110 and second defect 112 may be offset inward a desired distance from the corners. First defect 110 and second defect 112 may be spaced apart enough to permit easy access to contents when portion 118 is at least partially removed.

For example, first defect 110 and second defect 112 may be positioned proximate an edge of flexible package 100 and proximate a corner of first seal 106. First defect 110 and second defect 112 may also be positioned within front surface 102 or rear surface 104 proximate an edge that will form first seal 106 or second seal 108. First defect 110 and second defect 112 can also be located on different surfaces and at different seals.

For instance, first defect 110 may be located on front surface 102 and proximate an edge of first seal 106 and second defect 112 may be located on second surface 104 and proximate an edge of second seal 108. First defect 110 and second defect 112 may be located on front surface 104 and at first seal 106 and second seal 108, respectively. Outline 116 may connect first defect 110 and second defect 112 along front surface 104 such that portion 118 extends from first seal 106 to second seal 108.

First defect 110 and second defect 112 may be similar or may be different. First defect 110 and second defect 112 can be any structural weakness within a layer of material forming front surface 102 or rear surface 104 that facilitates removal of portion 118. For example, first defect 110 may be a notch located at first seal 106 and second defect may be a slit located at first seal 106. First defect 110 and second defect 112 may be a thinned portion of a surface or material forming the surface. For example, front surface 102 may be formed of a single layer material. First defect 110 may be located in front surface 102 and may be constructed by thinning a portion of front surface 102. The thinned portion of front surface 102 may facilitate removal of portion 118 by helping the user tear portion 118 from front surface 102. First defect 110 and second defect 112 may also include cuts within surfaces, such as front surface 102 and rear surface 104. Front surface 102 and rear surface 104 can also be partially separated along a portion of first seal 106. The separation may allow for easier complete separation of front surface 102 from rear surface 104 at first seal 106.

Flexible package 100, front surface 102, and rear surface 104 may be formed from a single piece of flexible material. As described herein, the single piece of flexible material may be wrapped to form a circular or oval shaped bag that is sealed via first seal 106, second seal 108 and a vertical seal 114.

Front surface 102 may also include an outline 116. Outline 116 may be an extension of first defect 110 or second defect 112. Outline 116 may connect first defect 110 to second defect 112. Outline 116 may define portion 118 of flexible package 100 to be removed from flexible package 100. Outline 116 may be a defect within front surface 102. For example, outline 116 may be a score or perforations located along front surface 102 and connect first defect 110 to second defect 112 that define portion 118.

As shown in FIGS. 1B-1D, upon separation of front surface 102 and rear surface 104 at first seal 106, second defect 112 may be exposed and may become operable to facilitate removal of portion 118. As shown in FIGS. 1C and 1D, upon exposure of second defect 112, front surface 102 may be torn along outline 116 all the way to first defect 110 such that portion 118 can be removed from flexible package 100 (FIG. 1E).

While FIGS. 1A-1E show a process for completely removing portion 118 from flexible package 100, portion 118 does not have to be completely removed from flexible package 100. For example, during the tearing process a user could stop before reaching first defect 110 and leave portion 118 partially attached as shown in FIG. 1D.

FIGS. 2A and 2B show a flexible package 200. Flexible package 200 includes a front surface 202 and a rear surface 204. A first seal 206 and a second seal 208 may seal flexible package 200 to form a bag as described above with regards to FIGS. 1A-1E. Flexible package 200 may include a first defect 210 and a second defect 212 concealed within first seal 206. Front surface 202 may also include an outline 216 that may define a portion 218 of flexible package that may be partially removed from flexible package 200.

Outline 216 may be an extension of first defect 210 or second defect 112. Outline 216 may connect first defect 210 and second defect 212 to a non-defect 220. Outline 216 may be a defect within front surface 202. For example, outline 216 may be a score or perforations located along front surface 202. By having non-defect 220, portion 218 may be partially removed from flexible package 200 as shown in FIG. 2B.

As shown in FIGS. 2A and 2B, upon separation of front surface 202 and rear surface 204 at first seal 206, first defect 210 and second defect 212 may be exposed and may become operable to facilitate partial removal of portion 118. As shown in FIG. 2B, upon exposure of first defect 210 and second defect 212, front surface 202 may be torn along outline 216 to non-defect 220 such that portion 218 can be partially removed from flexible package 200. Partial removal of portion 218 may allow for portion 218 to be temporarily folded back out of the way of a user in order to facilitate assess to a product stored in flexible package 200. In addition, portion 218 can be folded back into a position that may facilitate closing or resealing flexible package 200.

Non-defect 220 may also include reinforcing members that may hinder tearing of flexible package 200. The reinforcing members may be built into the flexible material used to form flexible package 200. The reinforcing member may be secured to a surface of the flexible material used to form flexible package 200. The reinforcing member may be located between a first layer of material used to form flexible package 200 and a second layer of material used to secure the reinforcing member to flexible package 200.

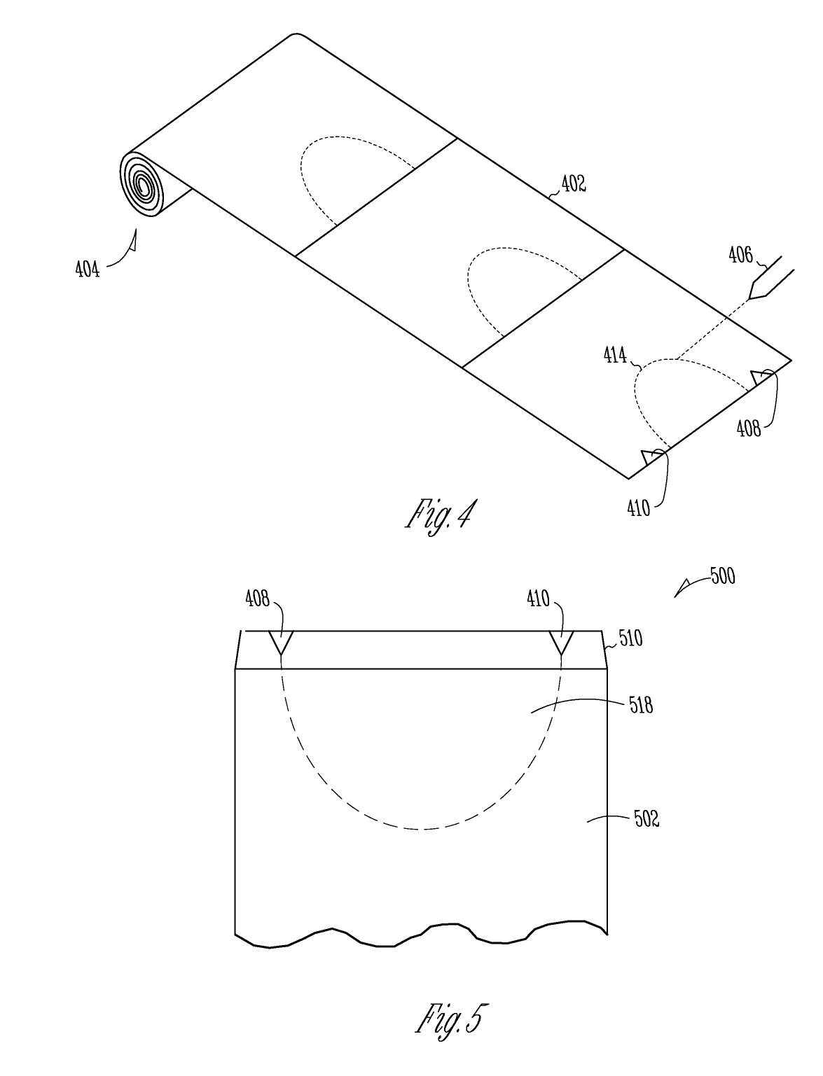

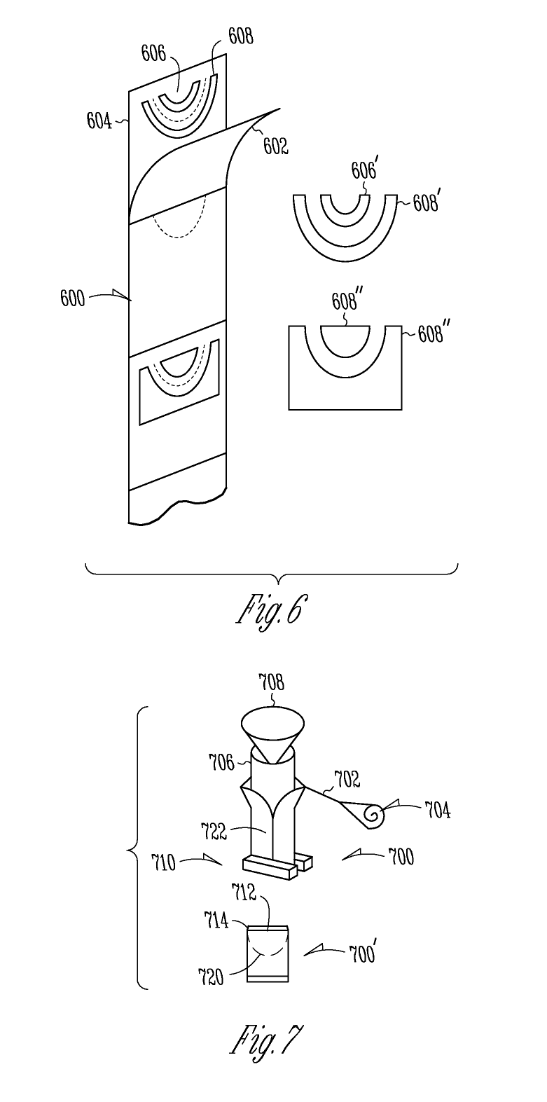

While outline 116 and outline 216 are depicted as having a “U” shape. Outlines may be of any shape and may include shapes with curved and straight lines. Non-limiting examples of shapes for outlines are shown in FIGS. 3A-3I. For instance, as shown in FIGS. 3C-3F and 3H show outlines having straight lines and FIGS. 3A, 3B, and 3G show outlines having curves. FIG. 3I shows an outline having both curved and straight lines.

FIG. 4 shows a method of creating an outline, such as outline 116 or outline 216, for a portion, such as portion 118 or portion 218, of a flexible package, such as flexible package 100 or flexible package 200, that is removable from the flexible package. During construction of the flexible package, a flexible material 402 may be unrolled from a spool of flexible material 404.

During production, a tool 406 may be used to create an outline 414. Non-limiting examples of tool 406 include a laser, a knife, a perforation tool, or a scoring instrument. For example, flexible material 402 may be a material with a first layer and a second layer. Tool 406 may be a perforation tool and may cut perforations into the first layer, but not the second layer of flexible material 402. The perforations may form outline 414 and create a defect in a front surface of the flexible package that allows a portion of the flexible package to be removed.

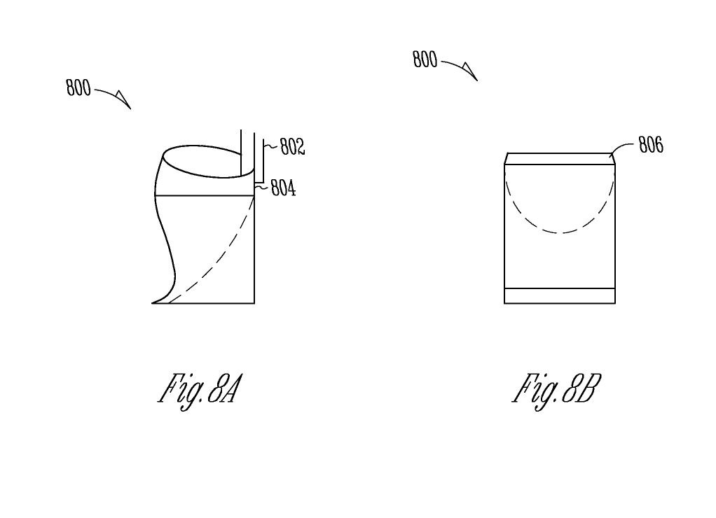

In addition to the outline, defects, such as first defect 110 and second defect 112, can be formed by tool 406. For example, defects may be a first notch 408 and a second notch 410 that are cut into flexible material 402. As shown in FIG. 5, when the flexible material is folded to form a flexible package, first notch 408 and second notch 410 may be integrated into a seal 510.

FIG. 5 shows first notch 408 and second notch 410 concealed within seal 510 of a flexible package 500. First notch 408 and second notch 410 can be formed as described above using tool 406. For instance, a laser can cut first notch 408 and second notch 410 in a portion of flexible material 402 that will become a front surface 502. Upon folding flexible material 402, portions of flexible material 402 may form a rear surface (not shown in FIG. 5). The portions of the flexible material 402 that form the rear surface contact front surface 502 to form seal 510. As described above, upon opening flexible package 500, first notch 408 and second notch 410 may be exposed and be operable to facilitate separation of a portion 518 of flexible package 500 from flexible package 500. Opening flexible package 500 may include separating front surface 502 and the rear surface by pulling front surface 502 and the rear surface apart to cause the surfaces to separate. Separation of front surface 502 and the rear surface may cause exposure of first notch 408 and second notch 410.

FIG. 6 shows a flexible material 600 having a first layer 602 and a second layer 604. A first reinforcement material 606 and a second reinforcement material 608 may be located between first layer 602 and second layer 604. During production, first reinforcement material 606, second reinforcement material 608, or both, can be placed between first layer 602 and second layer 604 and secured in place by adhesives or sealing first layer 602 to second layer 604 around first reinforcement material 606 and second reinforcement material 608. First reinforcement material 606 and second reinforcement material 608 can have different shapes as shown by example reinforcement materials 606′, 606″, 608′, and 608″.

First reinforcement material 606 and second reinforcement material 608 may be shaped to follow the contour of an outline, such outline 118. First reinforcement material 606 and second reinforcement material 608 may be offset from an outline. In addition, first reinforcement material 606 and second reinforcement material 608 may be used to define the portion of the flexible package to be removed. For example, first reinforcement material 606 and second reinforcement material 608 may be shaped as depicted in FIGS. 3A-3I. As a result, first reinforcement material 606 and second reinforcement material 608 may guide a tear within a material forming a flexible package such that the portion of the flexible package to be removed is defined by first reinforcement material 606 and second reinforcement material 608. In other words, one purpose of first reinforcement material 606 and second reinforcement material 608 may be to prevent random tearing of a flexible package while a portion of the flexible package is being removed.

FIG. 7 shows a method for manufacturing a bag 700. During production a flexible material 702 may be unrolled from a spool of flexible material 704 around a form 706. Form 706 may be hollow to allow for a product to be placed into bag 700 as bag 700 is being formed. For instance, the product may be a snack chip and the product may flow through a funnel 708 through form 706 into bag 700.

As described above with regards to FIG. 4, a first layer of flexible material corresponding to front surface 720 of bag 700 may be perforated. Flexible material 702 may be folded to form bag 700. As discussed with regards to FIG. 5, 8A, and 8B, a defect may be formed flexible material 702 in a location corresponding to proximate seal 712 to be formed by joining a front surface and rear surface 722. The bag may be sealed and cut from flexible material 702.

Spool of flexible material 702 may have had an outline created in a previous manufacturing process as described above. As flexible material 702 passes between a sealer 710, flexible material 702 may be sealed to both seal flexible package 700′ and cut flexible material 702 to separate flexible package 700′ from flexible material 702. The sealing and cutting process may also create a defect contained within a seal 712. As shown in FIG. 7, the defect may be a clipped corner 714. Upon separating a front surface 720 of flexible package 700 from a rear surface 722 of flexible package 700, seal 712 may separate and clipped corner 714 may expose a defect similar to that shown in FIGS. 4 and 5.

FIGS. 8A and 8B show a method for creating a defect in a flexible package 800. Flexible package 800 may be formed in a first process. In a second process, shown in FIG. 8A, a cutting instrument 802 may form a slit 804 in the material used to form flexible package 800. As shown in FIG. 8B, after the slit 804 has been formed, flexible package 800 can be sealed to form a seal 806. Slit 804 may be contained within seal 806 and upon being exposed, by opening flexible package 800, slit 804 may facilitate tearing the flexible material as described herein to remove a portion of flexible package 800.

Referring back to FIGS. 1A-1E, a method for removing a portion of a flexible package from the flexible package will be described. The method begins with flexible package 100 being in a sealed state. In the sealed state, flexible package 100 may hold a product. As shown in FIG. 1B, front surface 102 and rear surface 104 may be separated at seal 106. Such a separation is usually performed by the consumer by pinching the front and back surfaces a convenient distance from the seal to enable pulling the surfaces apart, releasing the seal first from about the middle of the seal adjacent the product contained within the bag, and proceeding to pull until the seal is nearly, if not completely released or separated. The separation of front surface 102 and rear surface 104 at seal 106 exposes first defect 110 and second defect 112. As shown in FIGS. 1C and 1D, flexible package 100 may be torn along outline 116. The method may end as shown in FIG. 1E with portion 118 removed from flexible package 100. Separating front surface 102 and rear surface 104 to expose first defect 110 and second defect 112, along with tearing flexible package to remove portion 118 may be performed as a continuous movement or as two separate movements.

Once portion 118 is removed from flexible package 100, a pocket may be created to facilitate access to the product. For example, a reinforcing member, such as described above, may be a pliable member. Once portion 118 is removed, the reinforcing member may be bent by a user to help hold flexible package 100 open to allow easy access to the product.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A flexible package comprising:
a front surface;
a rear surface coupled to the front surface, wherein the front surface and the rear surface form a bag to hold a product;
a seal joining the front surface to the rear surface to seal the bag; and
a defect located in one of the front surface and the rear surface proximate the seal, the defect being exposed and operable, upon separation of the front surface from the rear surface at the seal, to remove a portion of the bag from one of the front surface and the rear surface, removal of the portion operable to facilitate access to the product.

2. The flexible package of claim 1, further comprising a score extending from the defect along the front surface, the score defining the portion of the bag to be removed from the bag.

3. The flexible package of claim 1, further comprising a reinforcing member located along the front surface, the reinforcing member defining the portion of the bag to be removed from the bag.

4. The flexible package of claim 1, wherein the front surface and the rear surface are formed by a single piece of flexible material.

5. The flexible package of claim 4, wherein the defect comprises a slit formed in the flexible material at a crease formed by joinder of the front surface and the rear surface.

6. The flexible package of claim 4, wherein the defect comprises a clipped corner at an edge formed by joinder of the front surface and the rear surface.

7. The flexible package of claim 4, wherein the defect comprises a notch formed within the seal.

8. The flexible package of claim 4, wherein the single flexible material comprises a first layer of material and a second layer of material, wherein the defect comprises a perforation in the first layer of material and not the second layer of material.

9. The flexible package of claim 1 and further comprising an edible product and inert gas sealed within the bag

10. A flexible package comprising:
a flexible member forming a bag having a front surface and a rear surface, the bag containing a product;
a seal joining the front surface to the rear surface to seal the product within the bag; and
a defect located in one of the front surface and the rear surface proximate the seal, the defect being exposed and operable, upon separation of the front surface from the rear surface along the seal, to remove a portion of one of the front and rear surfaces of the bag to facilitate access to the product.

11. The flexible package of claim 10, further comprising a score extending from the defect along the front surface, the score defining a portion of the bag to be removed from the bag.

12. The flexible package of claim 10, further comprising a reinforcing member located along the front surface, the reinforcing member defining the portion of the bag to be removed from the bag.

13. The flexible package of claim 10, wherein the defect comprises a slit formed at a crease formed by joinder of the front surface and the rear surface.

14. The flexible package of claim 10, wherein the defect comprises a clipped corner at an edge formed by joinder of the front surface and the rear surface.

15. The flexible package of claim 10, wherein the flexible member comprises a first layer of material and a second layer of material, wherein the defect comprises a perforation in the first layer of material and not the second layer of material.

16. The flexible package of claim 10, wherein the product is edible.

17. A method manufacturing a bag having a removable portion, the method comprising:
perforating a first layer of the flexible material corresponding to a front surface of the bag;
folding the flexible material to form the bag, the bag including the front surface and a rear surface;
forming a defect in the flexible material in a location corresponding to proximate a seal to be formed by joining the front surface and the rear surface, the defect operable, upon separation of the front surface from the rear surface along the seal, to facilitate removal of the removable portion of one of the front surface of the bag;
sealing the bag; and
cutting the bag from flexible material.

18. The method of claim 17, wherein forming the defect comprises cutting a slit in the flexible material at a crease formed during folding the flexible material to form the bag.

19. The method of claim 17, wherein forming the defect comprises creating a notch in the flexible material at the location corresponding to proximate the seal.

20. The method of claim 17 further comprising locating a reinforcing member between the first layer of the flexible material and a second layer of the flexible material.
